(19) United States
(12) Patent Application Publication
(10) Pub. No.: US 2024/0340413 A1
(43) Pub. Date: Oct. 10, 2024

(54) METHOD, APPARATUS, AND MEDIUM FOR VIDEO PROCESSING

(71) Applicant: Bytedance Inc., Los Angeles, CA (US)

(72) Inventors: Jizheng XU, Los Angeles, CA (US); Li ZHANG, Los Angeles, CA (US)

(21) Appl. No.: 18/749,455

(22) Filed: Jun. 20, 2024

Related U.S. Application Data
(63) Continuation of application No. PCT/US2022/082088, filed on Dec. 20, 2022.
(60) Provisional application No. 63/292,279, filed on Dec. 21, 2021.

(51) Int. Cl. H04N 19/11; H04N 19/105; H04N 19/132; H04N 19/169; H04N 19/172; H04N 19/176; H04N 19/463

(52) U.S. Cl. CPC H04N 19/11; H04N 19/105; H04N 19/132; H04N 19/172; H04N 19/176; H04N 19/1883; H04N 19/463

(57) ABSTRACT

Embodiments of the disclosure provide a solution for video processing. A method for video processing is proposed. The method includes: determining, during a conversion between a video unit of a video and a bitstream of the video, a first reference area for intra block copy (IBC) of the video unit based on a second reference area for intra template matching, the video unit being applied with an IBC mode; determining a block vector for the video unit in the first reference area; and performing the conversion based on the block vector.

### CROSS REFERENCE TO RELATED APPLICATIONS

This application is a continuation of International Application No. PCT/US2022/082088, filed on Dec. 20, 2022, which claims the benefit of the U.S. Provisional Application No. 63/292,279 filed on Dec. 21, 2021. The entire contents of these applications are hereby incorporated by reference in their entireties.

### FIELD

Embodiments of the present disclosure relates generally to video coding techniques, and more particularly, to intra block copy buffer design.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, during a conversion between a video unit of a video and a bitstream of the video, a first reference area for intra block copy (IBC) of the video unit based on a second reference area for intra template matching, the video unit being applied with an IBC mode; determining a block vector for the video unit in the first reference area; and performing the conversion based on the block vector. Compared with the conventional solution, embodiments of the present disclosure can advantageously improve the coding efficiency.

In a second aspect, another method for video processing is proposed. The method comprises: determining, during a conversion between a video unit of a video and a bitstream of the video, a block vector for the video unit, wherein the video unit is applied with an intra block copy (IBC) mode and has a first size parameter and a second size parameter, the block vector has a first direction parameter and a second direction parameter, and if the first direction parameter is equal to a predetermined number, an unsigned integer which depends on the first size parameter represents the second direction parameter; and performing the conversion based on the block vector. Compared with the conventional solution, embodiments of the present disclosure can advantageously improve the coding efficiency.

In a third aspect, another method for video processing is proposed. The method comprises: determining, during a conversion between a video unit of a video and a bitstream of the video, a set of reconstructed samples above a current coding tree unit (CTU) row of the video unit are used for intra block copy (IBC) reference; and performing the conversion based on the set of reconstructed samples. Compared with the conventional solution, embodiments of the present disclosure can advantageously improve the coding efficiency.

In a fourth aspect, another method for video processing is proposed. The method comprises: determining, during a conversion between a video unit of a video and a bitstream of the video, whether an intra block copy (IBC) mode is disallowed for the video unit based on a size of the video unit; and performing the conversion based on the determining. Compared with the conventional solution, embodiments of the present disclosure can advantageously improve the coding efficiency.

In a fifth aspect, an apparatus for processing video data is proposed. The apparatus for processing video data comprising a processor and a non-transitory memory with instructions thereon, wherein the instructions upon execution by the processor, cause the processor to perform a method in accordance with the first, second, third, or fourth aspect.

In a sixth aspect, an apparatus for processing video data is proposed. The non-transitory computer-readable storage medium storing instructions that cause a processor to perform a method in accordance with the first, second, third, or fourth aspect.

In a seventh aspect, a non-transitory computer-readable recording medium is proposed. The non-transitory computer-readable recording medium storing a bitstream of a video which is generated by a method performed by a video processing apparatus, wherein the method comprises: determining a first reference area for intra block copy (IBC) of a video unit of the video based on a second reference area for intra template matching, the video unit being applied with an IBC mode; determining a block vector for the video unit in the first reference area; and generating a bitstream of the video unit based on the block vector.

In an eighth aspect, another method for video processing is proposed. The method for storing bitstream of a video, comprising: determining a first reference area for intra block copy (IBC) of a video unit of the video based on a second reference area for intra template matching, the video unit being applied with an IBC mode; determining a block vector for the video unit in the first reference area; generating a bitstream of the video unit based on the block vector; and storing the bitstream in a non-transitory computer-readable recording medium.

In a ninth aspect, another non-transitory computer-readable recording medium is proposed. The non-transitory computer-readable recording medium storing a bitstream of a video which is generated by a method performed by a video processing apparatus, wherein the method comprises: determining a block vector for the video unit, wherein the video unit is applied with an intra block copy (IBC) mode and has a first size parameter and a second size parameter, and the block vector has a first direction parameter and a second direction parameter, and if the first direction parameter is equal to a predetermined number, an unsigned integer which depends on the first size parameter represents the second direction parameter; and generating a bitstream of the video unit based on the block vector.

In a tenth aspect, another method for video processing is proposed. The method for storing bitstream of a video, comprising: determining a block vector for a video unit of the video, wherein the video unit is applied with an intra block copy (IBC) mode and has a first size parameter and a second size parameter, and the block vector has a first direction parameter and a second direction parameter, and if the first direction parameter is equal to a predetermined number, an unsigned integer which depends on the first size parameter represents the second direction parameter; and generating a bitstream of the video unit based on the block vector; and storing the bitstream in a non-transitory computer-readable recording medium.

In an eleventh aspect, another non-transitory computer-readable recording medium is proposed. The non-transitory computer-readable recording medium storing a bitstream of a video which is generated by a method performed by a video processing apparatus, wherein the method comprises: determining a set of reconstructed samples above a current coding tree unit (CTU) row of a video unit of the video are used for intra block copy (IBC) reference; and generating a bitstream of the video unit based on the set of reconstructed samples.

In a twelfth aspect, another method for video processing is proposed. The method for storing bitstream of a video, comprising: determining a set of reconstructed samples above a current coding tree unit (CTU) row of a video unit of the video are used for intra block copy (IBC) reference; generating a bitstream of the video unit based on the set of reconstructed samples; and storing the bitstream in a non-transitory computer-readable recording medium.

In a thirteenth aspect, another non-transitory computer-readable recording medium is proposed. The non-transitory computer-readable recording medium storing a bitstream of a video which is generated by a method performed by a video processing apparatus, wherein the method comprises: determining, based on a size of a video unit of the video, whether an intra block copy (IBC) mode is disallowed for the video unit; and generating a bitstream of the video unit based on the determining.

In a fourteenth aspect, another method for video processing is proposed. The method for storing bitstream of a video, comprising: determining, based on the size of a video unit of the video, whether an intra block copy (IBC) mode is disallowed for the video unit; generating a bitstream of the video unit based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a block diagram of intra template matching search area used;

FIG. 5 illustrates a block diagram of MMVD Search point;

FIG. 6 illustrates a flow chart of a method according to embodiments of the present disclosure;

FIG. 7 illustrates a flow chart of a method according to embodiments of the present disclosure;

FIG. 8 illustrates a flow chart of a method according to embodiments of the present disclosure;

FIG. 9 illustrates a flow chart of a method according to embodiments of the present disclosure; and

FIG. 10 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

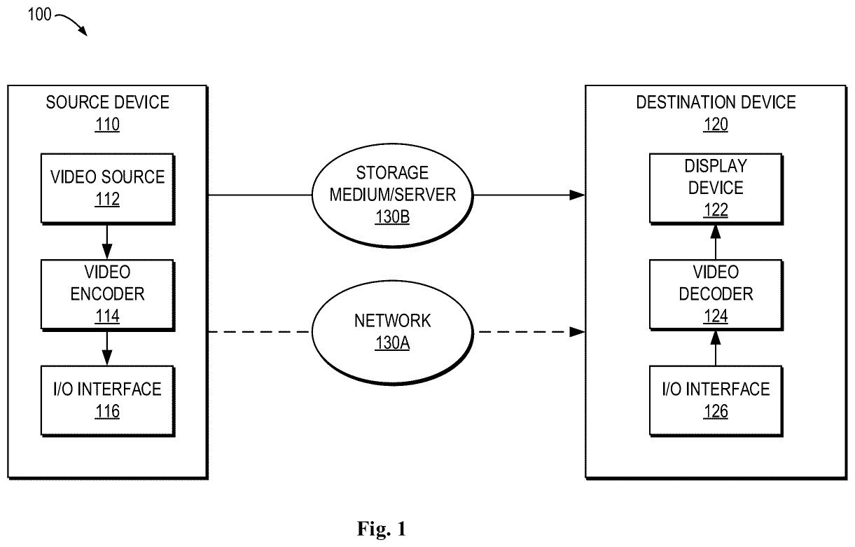

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

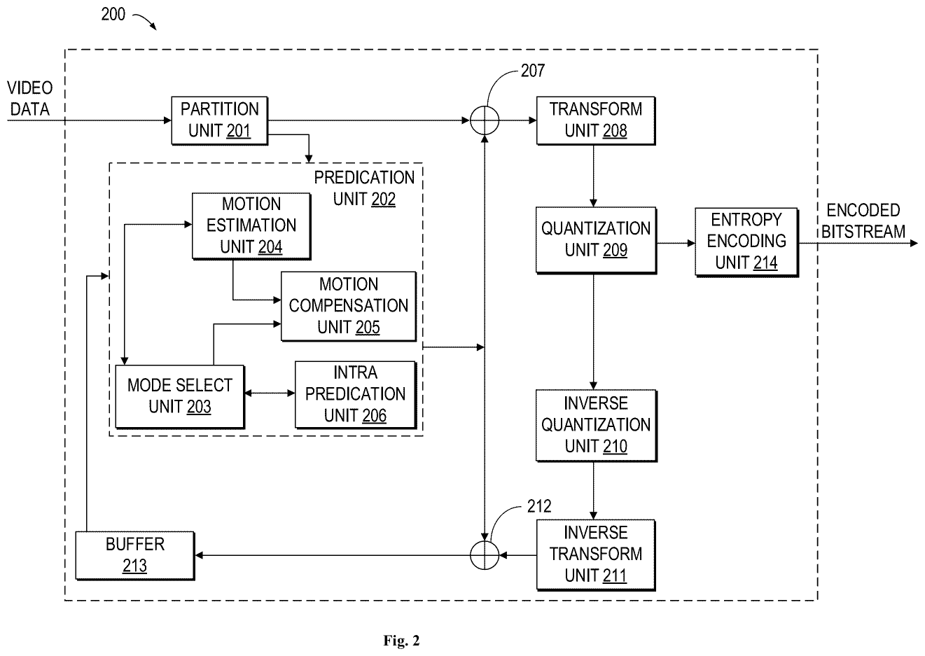

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

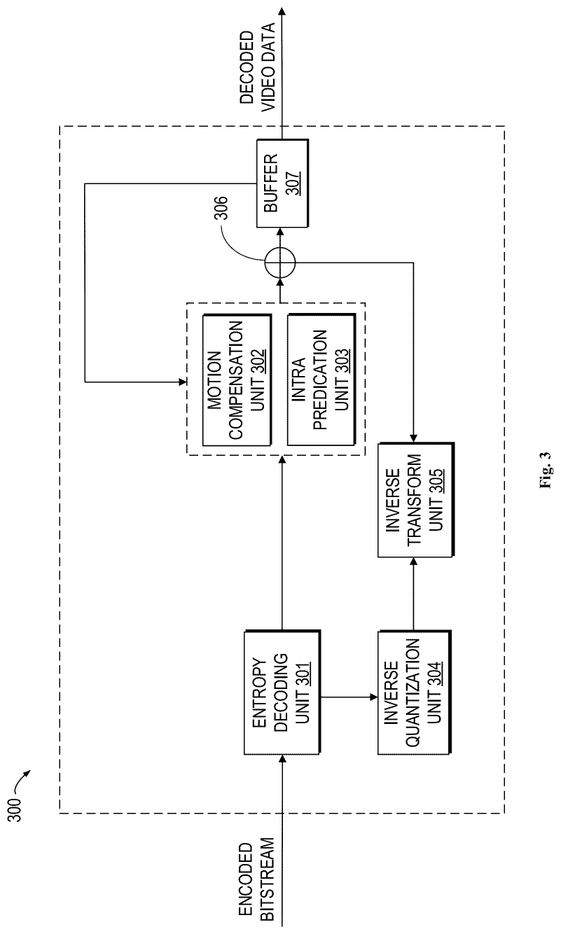

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video coding technologies. Specifically, it is related to intra block copy in video coding. It may be applied to the standard under development or planning, e.g. next generation video coding standards beyond the Versatile Video Coding standard. It may be also applicable to future video coding standards or video codec.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC), H.265/HEVC and the latest H.266/Versatile Video Coding (VVC) standards. Since H.261, the video coding standards are based on the hybrid video coding structure wherein temporal prediction plus transform coding are utilized. To explore the future video coding technologies beyond VVC, Joint Video Exploration Team (JVET) started development of the Enhanced Compression Model in April 2021. Since then, many new methods have been adopted by JVET and put into the reference software. The latest software can be found at https://vcgit.hhi.fraunhofer.de/ecm/ECM/-/tags/ECM-2.0.

### 2.1 Virtual Pipeline Data Unit

Virtual pipeline data units (VPDUs) are defined as non-overlapping M×M-luma (L)/N×N-chroma (C) units in a picture. In hardware decoders, successive VPDUs are processed by multiple pipeline stages at the same time; different stages process different VPDUs simultaneously. The VPDU size is roughly proportional to the buffer size in most pipeline stages, so it is very important to keep the VPDU size small. In HEVC hardware decoders, the VPDU size is set to maximum transform block (TB) size. In VVC, the VPDU size is increased to 64×64-luma/32×32-chroma for 4:2:0 format.

### 2.2 Intra Block Copy in VVC

To support Intra Block Copy (IBC) in VVC, a virtual buffer concept is used for reference buffer management. As in JVET-2001-v2 document, given the CTU size, i.e., CtbSizeY, the buffer width in luma sample is defined as:

$$IbcBufWidthY = 256 * 128 / CtbSizeY .$$

The cossponding chroma IBC buffer is defined as:

$$IbcBufWidthC = IbcBufWidthY / SubWidthC ,$$

where SubWidthC depends on chroma format, which is defined in the following table.

TABLE 1
SubWidthC and SubHeightC values derived
from sps_chroma_format_idc

| | Chroma | | |
|---|---|---|---|
| sps_chroma_format_idc | format | SubWidthC | SubHeightC |
| 0 | Monochrome | 1 | 1 |
| 1 | 4:2:0 | 2 | 2 |
| 2 | 4:2:2 | 2 | 1 |
| 3 | 4:4:4 | 1 | 1 |

The height of the buffer in luma sample is CtbSizeY.

In VVC, a VPDU concept is applied to enable parallel decoding among different VPDUs within a CTU to increase the decoding throughput. Its size can be derived from CTU size, as in the following table.

TABLE 2
VPDU size derived from CTU size in VVC

| CTU size | VPDU size |
|---|---|
| 128 × 128 | 64 × 64 |
| 64 × 64 | 64 × 64 |
| 32 × 32 | 32 × 32 |

VVC only supports CTU size being 32×32, 64×64 and 128×128. At the beginning of decoding a CTU row in a slice, the luma IBC buffer is reset to be −1. Before decoding a new VPDU, the luma buffer corresponding to that VPDU is also reset to be −1. After finishing decoding a VPDU's data prior to loop filtering, the corresponding buffer samples are updated to the VPDU data that have been just reconstructed.

After a CU has been reconstruted, the reconstructed samples before loop-filtering are stored in the IBC buffer as follows (as described in the text of JVET-T2001-v2):

The following assignments are made for i=0 . . . nCurrSw−1, j=0 . . . nCurrSh−1:

$$xVb = ( xCurr + i ) \% ( ( cIdx = = 0 ) ? IbcBufWidth Y : IbcBufWidthC ) \qquad ( 1197 )$$

$$yVb = ( yCurr + j ) \% ( ( cIdx = = 0 ) ? CtbSizeY : ( CtbSizeY / subHeightC ) ) \qquad ( 1198 )$$

$$IbcVirBuf [ cIdx ] [ xVb ] [ yVb ] = recSamples [ xCurr + i ] [ yCurr + j ] . \qquad ( 1199 )$$

If a CU uses IBC mode, its prediction is formed as follows:

When cIdx is equal to 0, for x=xCb . . . xCb+cbWidth−1 and y=yCb . . . yCb+cbHeight−1, the following applies:

$$xVb = ( x + ( bv [ 0 ] ≫ 4 ) ) \& ( IbcBufWidthY - 1 ) \qquad ( 1096 )$$

$$yVb = ( y + ( bv [ 1 ] ≫ 4 ) ) \& ( CtbSizeY - 1 ) \qquad ( 1097 )$$

$$predSamples [ x - x Cb ] [ y - yCb ] = IbcVirBuf [ 0 ] [ xVb ] [ yVb ] . \qquad ( 1098 )$$

When cIdx is not equal to 0, for x=xCb/Sub WidthC . . . xCb/Sub WidthC+cbWidth/Sub WidthC−1 and y=yCb/SubHeightC . . . yCb/SubHeightC+cbHeight/SubHeightC−1, the following applies:

$$xVb = ( x + bv [ 0 ] ≫ ( 3 + SubWidthC ) ) ) \& ( IbcBufWidthC - 1 ) \qquad ( 1099 )$$

$$yVb = ( y + ( bv [ 1 ] ≫ ( 3 + SubHeightC ) ) ) \& ( ( CtbSizeY / subHeightC ) - 1 ) \qquad ( 1100 )$$

$$predSamples [ x - ( xCb / SubWidthC ) ] [ \text{} y - ( yCb / SubHeightC ) ] = IbcVirBuf [ cIdx ] [ xVb ] [ yVb ] . \qquad ( 1101 )$$

### 2.3 Enhanced Compression Model

After finishing the 1^{st} version of VVC, JVET started to develop a test model to explore further coding efficiency improvement over VVC. The test model is named Enhanced Compression Model. Many new coding tools, e.g. intra temporal matching, dependent quantization with 8-states, are integrated into the VVC test model to improve the coding efficiency.

It is noted that in ECM, the CTU size can be extended to 256×256. However, the IBC buffer with the extended CTU size and corresponding processing are undefined.

### 2.4 General Virtual Buffer

In an example solution, several bullets are about CTU size being 256×256. They are listed as follows:
11. When CTU/CTB size is 256×256, the corresponding IBC virtual buffer may be of size 64×256 to track availability of reference samples, i.e. ibcBufW=64, ibcBufH=256.
   a. In one example, before decoding a VPDU with top-left position (x0, y0), the corresponding VPDU row (0, y0% 256) in the IBC buffer will be set to −1.
12. When CTU/CTB size is 256×256, the corresponding IBC virtual buffer may be of size 128×256 to track availability of reference samples, i.e. ibcBufW=128, ibcBufH=256.
   a. In one example, only one VPDU may be kept (excluding the current VPDU) for each VPDU row in the buffer except for a certain VPDU row.
      i. In one example, only one VPDU may be kept (excluding the current VPDU) for each VPDU row in the buffer except for the last VPDU row.

This documents presents more systematic and general design to handle large CTU.

### 2.5 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

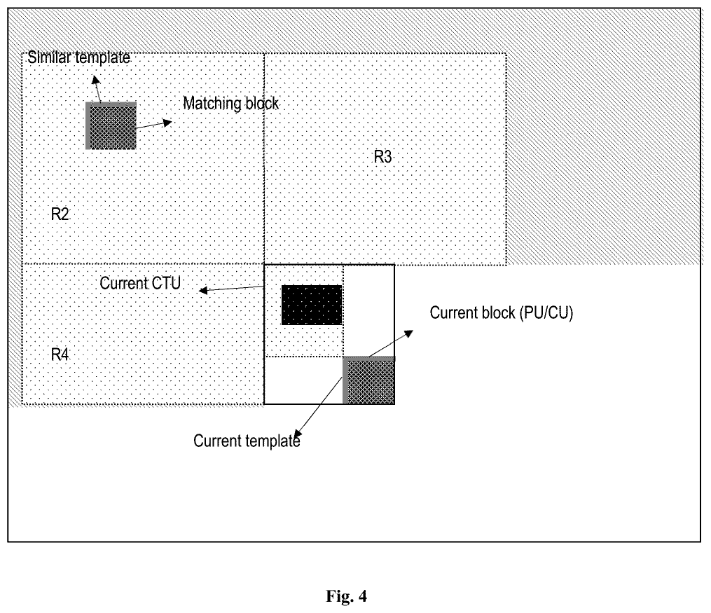

The prediction signal is generated by matching the L-shaped causal neighbor of the current block with another block in a predefined search area in FIG. 4 consisting of:
R1: current CTU,
R2: top-left CTUs,
R3: above CTUs,
R4: left CTUs.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:
SearchRange_w=a*BlkW
SearchRange_h=a*BlkH.

Where ‘a’ is a constant that controls the gain/complexity trade-off. In practice, ‘a’ is equal to 5. The Intra template matching tool is enabled for CUs with size less than or equal to 64 in width and height. This maximum CU size for Intra template matching is configurable.

The Intra template matching prediction mode is signaled at CU level through a dedicated flag.

2.6 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The mmvd candidate flag is signalled to specify which one is used between the first and second merge candidates.

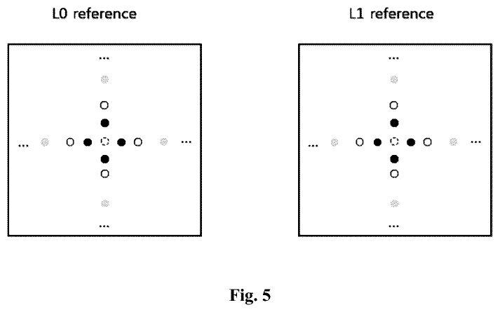

Distance index specifies motion magnitude information and indicate the pre-defined offset from the starting point. As shown in FIG. 5, an offset is added to either horizontal component or vertical component of starting MV. The relation of distance index and pre-defined offset is specified in Table 3.

TABLE 3
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 4. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 4 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 4 specifies the sign of MV offset added to the list0 MV component of starting MV and the sign for the list1 MV has opposite value. Otherwise, if the difference of POC in list 1 is greater than list 0, the sign in Table 4 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

TABLE 4
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 3. Potential Problems

In the current design of IBC buffer design, there are some issues and improvement to alleviate those is possible.
1) The current IBC buffer design only supports CTU size being 128, 64 or 32. It does not support CTU size larger than 128, e.g. 256 in ECM.
2) The current IBC buffer design does not support VPDU size larger than 64×64.
3) The current IBC buffer design does not support non-square CTU.
4) The current IBC buffer design does not support non-square VPDU.

### 4. Embodiments of the Present Disclosure

To solve the above problems, methods as summarized below are disclosed. Embodiments should be considered as examples to explain the general concepts and should not be interpreted in a narrow way. Furthermore, these embodiments can be applied individually or combined in any manner.

1) The width of the IBC buffer may be 2^{m} times of the CTU width, where m is a positive integer.
a. In one example, when the CTU width in luma sample is 256, the IBC buffer width in luma sample may be 256.
b. In one example, when the CTU width in luma sample is 256, the IBC buffer width in luma sample may be 512.
c. In one example, when the CTU width in luma sample is 384, the IBC buffer width in luma sample may be 384.
d. In one example, when the CTU width in luma sample is 384, the IBC buffer width in luma sample may be 384*2.
e. In one example, when the CTU width in luma sample is 512, the IBC buffer width in luma sample may be 512.
f. In one example, when the CTU width in luma sample is 512, the IBC buffer width in luma sample may be 512*2.

2) The height of the IBC buffer may be 2ⁿ times of the CTU height, where n is a positive integer.
a. In one example, when the CTU height in luma sample is 256, the IBC buffer height in luma sample may be 256.
b. In one example, when the CTU height in luma sample is 256, the IBC buffer height in luma sample may be 512.

3) The width of the IBC buffer may be 2^{k} times of the VPDU width, where k is a positive integer.
a. In one example, when the VPDU width in luma sample is 128, the IBC buffer width in luma sample may be 128.
b. In one example, when the VPDU width in luma sample is 128, the IBC buffer width in luma sample may be 256.
c. In one example, when the VPDU width in luma sample is 128, the IBC buffer width in luma sample may be 512.
d. In one example, when the VPDU width in luma sample is 256, the IBC buffer width in luma sample may be 256.
e. In one example, when the VPDU width in luma sample is 256, the IBC buffer width in luma sample may be 512.
f. In one example, when the VPDU width in luma sample is 256, the IBC buffer width in luma sample may be 1024.

4) The height of the IBC buffer may be 2^{l} times of the VPDU height, where l is a positive integer.
a. In one example, when the VPDU height in luma sample is 128, the IBC buffer height in luma sample may be 128.
b. In one example, when the VPDU height in luma sample is 128, the IBC buffer height in luma sample may be 256.
c. In one example, when the VPDU height in luma sample is 256, the IBC buffer height in luma sample may be 256.
d. In one example, when the VPDU height in luma sample is 256, the IBC buffer height in luma sample may be 512.

5) When considering IBC buffer, VPDU size may be always be set to be CTU size.
a. In one example, VPDU width may be se to be CTU width.
b. In one example, VPDU height may be se to be CTU height.

6) The validity check for a block vector may depend on the height of the IBC buffer, which may or may not be equal to be the CTU height.
a. In one example, the validity of a block vector may be determined by whether the reference block derived from the IBC buffer with parameters of buffer width and height contains invalid sample values.

7) Resetting of the IBC buffer may depend on the height of the IBC buffer, which may or may not be equal to be the CTU height.
a. In one example, at the beginning of decoding a CTU row in a slice, the resetting of the IBC buffer applies to all samples within the buffer width and height.
b. In one example, after reconstructing a VPDU, the corresponding block derived from the IBC buffer with parameters of buffer width and height may be reset.
c. In one example, after reconstructing a CU, the corresponding block derived from the IBC buffer with parameters of buffer width and height may be reset.
d. In one example, after reconstructing a CTU, the corresponding block derived from the IBC buffer with parameters of buffer width and height may be reset.

8) In above examples, the variables m, n, k, l may be dependent on the CTU width/height.
a. Alternatively, indication of the value of the variable or the width/height of the IBC buffer may be signalled.

9) In above examples, the variables m and n may be set to same or different values.
a. Alternatively, whether to set m and n to be same values may depend on whether the CTU width and height are equal.

10) In above examples, the variables k and l may be set to same or different values.
a. Alternatively, whether to set k and l to be same values may depend on whether the VPDU width and height are equal.

11) The reference area for IBC may be set corresponding to the reference area for intra template matching.
a. Alternatively, the reference area for intra template matching may be set corresponding to the reference area for IBC.
b. In one example, the reference area for each IBC block may be set to be the maximum area including the template samples assuming that the block is coded in the intra template matching mode.
c. In one example, the reference area for each IBC block may be set to be the maximum area excluding the template samples assuming that the block is coded in the intra template matching mode.

12) For a block vector (BVx, BVy) for a block with width being W and height being H, when BVx is equal to 0, an unsigned integer depending on H may be coded to represent BVy.
a. In one example, h≙((abs (BVy)−H) may be coded using EG1 and BVy may be recontructed as −(h+H).

13) For a block vector (BVx, BVy) for a block with width being W and height being H, when BVy is equal to 0, an unsigned integer depending on W may be coded to represent BVx.
a. In one example, w≙((abs (BVx)−W) may be coded using EG1 and BVx may be recontructed as −(w+W).

14) IBC may be disallowed for certain CTU/CTB sizes.
a. In one example, IBC may be disallowed when CTU/CTB width and/or height are equal to or larger than a certain value.
   i. In one example, the value is 128.
   ii. In one example, the value is 256.
b. When IBC is disallowed for those CTU size, the flag to indicate IBC usage may be skipped and inferred to be 0.

15) Reconstructed samples above the current CTU row and within a slice may be used for IBC reference.
a. Alternatively, reconstructed samples above the current CTU row and within a tile may be used for IBC reference.
   i. In one example, reconstructed samples outside of the current tile should not be used as IBC reference.
b. Alternatively, reconstructed samples above the current CTU row and within a subpicture may be used for IBC reference.
   i. In one example, reconstructed samples outside of the current subpicture should not be used as IBC reference.

### 5. Embodiments

Without further mentioned, the following embodiments are based on the specification text described in JVET-T2001-v2. Most relevant parts that have been added or modified are highlighted, and some of the deleted parts are highlighted in strikethrough fonts. There may be some other changes that are editorial in nature and thus not highlighted.

### 5.1 Embodiment #1

When CTU size in luma sample is 256×256, the following applies:

$$IbcBufWidthY = 256 * 256 / CtbSizeY \qquad ( 45 )$$

$$IbcBufWidthC = IbcBufWidthY / SubWidthC \qquad ( 46 )$$

$$VSize = Min ( 64 , CtbSizeY ) . \qquad ( 47 )$$

### 5.2 Embodiment #2

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = Min ( 64 , CtbSizeY ) . \qquad ( 47 )$$

### 5.3 Embodiment #3

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = Min ( 128 , CtbSizeY ) . \qquad ( 47 )$$

### 5.4 Embodiment #4

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = Min ( 256 , CtbSizeY ) . \qquad ( 47 )$$

### 5.5 Embodiment #5

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = CtbSizeY - . \qquad ( 47 )$$

### 5.6 Embodiment #6

When CTU size in luma sample is 256×256, the following applies:

$$IbcBufWidthY = 256 * 128 / CtbSizeY \qquad ( 45 )$$

$$IbcBufWidthC = IbcBufWidthY / SubWidthC \qquad ( 46 )$$

$$VSize = Min ( 64 , CtbSizeY ) \qquad ( 47 )$$

$$IbcBufHeightY = CtbSizeY ≫ 1.$$

### 8.6.2 Derivation Process for Block Vector Components for IBC Blocks

### 8.6.2.1 General

Inputs to this process are:
a luma location (xCb, yCb) of the top-left sample of the current luma coding block relative to the top-left luma sample of the current picture,
a variable cbWidth specifying the width of the current coding block in luma samples,
a variable cbHeight specifying the height of the current coding block in luma samples.

Outputs of this process are:
the luma block vector in 1/16 fractional-sample accuracy bvL.

The luma block vector bvL is derived as follows:
The derivation process for IBC luma block vector prediction as specified in clause 8.6.2.2 is invoked with the luma location (xCb, yCb), the variables cbWidth and cbHeight inputs, and the output being the luma block vector bvL.
When general_merge_flag [xCb][yCb] is equal to 0, the following applies:
   1. The variable bvd is derived as follows:

$$bvd [ 0 ] = MvdL 0 [ xCb ] [ yCb ] [ 0 ] \qquad ( 1081 )$$

$$bvd [ 1 ] = MvdL 0 [ xCb ] [ yCb ] [ 1 ] . \qquad ( 1082 )$$

2. The rounding process for motion vectors as specified in clause 8.5.2.14 is invoked with mvX set equal to bvL, rightShift set equal to AmvrShift, and leftShift set equal to AmvrShift as inputs and the rounded bvL as output.
3. The luma block vector bvL is modified as follows:

$$u [ 0 ] = ( bvL [ 0 ] + bvd [ 0 ] ) ( {2}^{18} - 1 ) \qquad ( 1083 )$$

$$bvL [ 0 ] = ( u [ 0 ] >= {2}^{17} ) ? ( u [ 0 ] - {2}^{18} ) : u [ 0 ] \qquad ( 1084 )$$

$$u [ 1 ] = ( bvL [ 1 ] + bvd [ 1 ] ) \& ( {2}^{18} - 1 ) \qquad ( 1085 )$$

$$bvL [ 1 ] = ( u [ 1 ] >= {2}^{17} ) ? ( u [ 1 ] - {2}^{18} ) : u [ 1 ] \qquad ( 1086 )$$

$$NOTE - The resulting values of bvL [ 0 ] and bvL [ 1 ] are in the range of - {2}^{17} to {2}^{17} - 1 , inclusive .$$

When IsGt4by4 is equal to TRUE, the updating process for the history-based block vector predictor list as specified in clause 8.6.2.6 is invoked with luma block vector bvL.

It is a requirement of bitstream conformance that the luma block vector bvL shall obey the following constraints:
IbcVirBuf[0][(x+(bvL[0]>>4)) & (IbcBufWidthY−1)][(y+(bvL[1]>>4)) & (I bcBufHeightY−1)] shall not be equal to −1 for x=xCb . . . xCb+cbWidth−1 and y=yCb . . . yCb+cbHeight−1.

$$……$$

$$xVb = ( xCurr + i ) \% ( ( cIdx = = 0 ) ? IbcBufWidthY : IbcBufWidthC ) \qquad ( 1197 )$$

$$yVb = ( yCurr + j ) \% ( ( cIdx = = 0 ) ? IbcBufHeightY : ( IbcBufHeightY / subHeightC ) ) \qquad ( 1198 )$$

$$IbcVirBuf [ cIdx ] [ xVb ] [ yVb ] = recSamples [ xCurr + i ] [ yCurr + j ] \qquad ( 1199 )$$

$$……$$

When cIdx is equal to 0, for x=xCb . . . xCb+cbWidth−1 and y=yCb . . . yCb+cbHeight−1, the following applies:

$$xVb = ( x + ( bv [ 0 ] ≫ 4 ) ) \& ( IbcBufWidthY - 1 ) \qquad ( 1096 )$$

$$yVb = ( y + ( bv [ 1 ] ≫ 4 ) ) \& ( IbcBufHeightY - 1 ) \qquad ( 1097 )$$

$$predSamples [ x - xCb ] [ y - yCb ] = IbcVirBuf [ 0 ] [ xVb ] [ yVb ] . \qquad ( 1098 )$$

When cIdx is not equal to 0, for x=xCb/Sub WidthC . . . xCb/Sub WidthC+cbWidth/Sub WidthC−1 and y=yCb/SubHeightC . . . yCb/SubHeightC+cbHeight/SubHeightC−1, the following applies:

$$xVb = ( x + ( bv [ 0 ] ≫ ( 3 + SubWidthC ) ) ) \& ( IbcBufWidthC - 1 ) \qquad ( 1099 )$$

$$yVb = ( y + ( bv [ 1 ] ≫ ( 3 + SubHeightC ) ) ) \& ( ( IbcBufHeightY / subHeightC - 1 ) \qquad ( 1100 )$$

$$predSamples [ x - ( xCb / SubWidthC ) ] [ \text{} y - ( yCb / SubHeightC ) ] = IbcVirBuf [ cIdx ] [ xVb ] [ yVb ] . \qquad ( 1101 )$$

As used herein, the term “video unit” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block (PB), a transform block (TB), a block, a sub-block of a block, a sub-region within the block, or a region that comprises more than one sample or pixel.

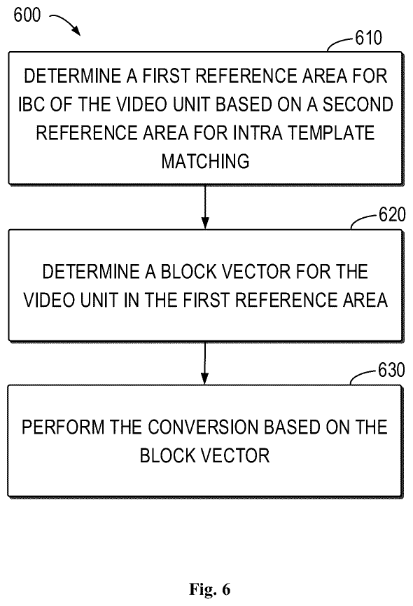

FIG. 6 illustrates a flowchart of a method 600 for video processing in accordance with some embodiments of the present disclosure. The method 600 may be implemented during a conversion between a block and a bitstream of the block.

At block 610, during a conversion between a video unit of a video and a bitstream of the video, a first reference area for intra block copy (IBC) of the video unit based on a second reference area for intra template matching is determined. The video unit is applied with an IBC mode. In the IBC mode, prediction samples may be derived from blocks of sample values of a same video region as determined by block vectors.

At block 620, a block vector for the video unit in the reference area is determined. At block 630, the conversion is performed based on the block vector. In some embodiments, the conversion may comprise encoding the video unit into the bitstream. In some embodiments, the conversion may comprise decoding the video unit from the bitstream.

According to embodiments of the present disclosure, the IBC reference area can be determined in association with the intra template matching mode. Compared with the conventional solution, embodiments of the present disclosure can advantageously improve the coding efficiency.

Implementations of the present disclosure can be described in view of the following clauses, the features of which can be combined in any reasonable manner.

In some embodiments, the first reference area for IBC may be set corresponding to the second reference area for intra template matching. Alternatively, the second reference area for intra template matching may be set corresponding to the first reference area for IBC. In some other embodiments, a reference area for each IBC block may be set to a maximum area including a set of template samples if the vide unit is coded in the intra template matching mode. In one example, the reference area for each IBC block may be set to be the maximum area including the template samples assuming that the block is coded in the intra template matching mode. In some other embodiments, a reference area for each IBC block may be set to a maximum area excluding a set of template samples if the vide unit is coded in the intra template matching mode. In one example, the reference area for each IBC block may be set to be the maximum area excluding the template samples assuming that the block is coded in the intra template matching mode.

In some embodiments, a first reference area for intra block copy (IBC) of a video unit of the video is determined based on a second reference area for intra template matching, and the video unit is applied with an IBC mode. A block vector for the video unit in the first reference area is determined. A bitstream of the video unit is generated based on the block vector.

In some embodiments, a first reference area for intra block copy (IBC) of a video unit of the video is determined based on a second reference area for intra template matching, the video unit is applied with an IBC mode. A block vector for the video unit in the first reference area is determined. A bitstream of the video unit is generated based on the block vector. The bitstream is stored in a non-transitory computer-readable recording medium.

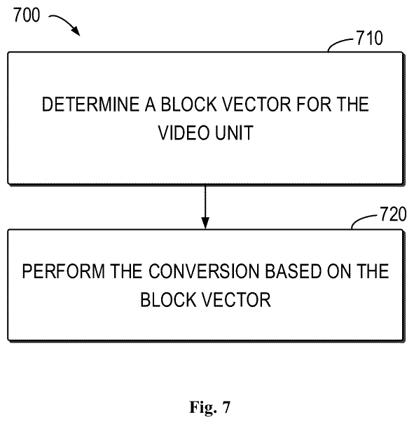

FIG. 7 illustrates a flowchart of a method 700 for video processing in accordance with some embodiments of the present disclosure. The method 700 may be implemented during a conversion between a block and a bitstream of the block.

As shown in FIG. 7, at block 710, during a conversion between a video unit of a video and a bitstream of the video, a block vector for the video unit is determined. The video unit is applied with an intra block copy (IBC) mode. The video unit has a first size parameter and a second size parameter. The block vector also has a first direction parameter and a second direction parameter. In this case, if the first direction parameter is equal to a predetermined number, an unsigned integer which depends on the first size parameter represents the second direction parameter; and performing the conversion based on the block vector.

At block 720, the conversion is performed based on the block vector. In some embodiments, the conversion may comprise encoding the video unit into the bitstream. In some embodiments, the conversion may comprise decoding the video unit from the bitstream.

According to embodiments of the present disclosure, if on direction parameter of the block vector is set to a predetermined number, the other direction parameter of the block vector may be determined based on a size parameter of the video unit. Compared with the conventional solution, embodiments of the present disclosure can advantageously improve the coding efficiency.

Implementations of the present disclosure can be described in view of the following clauses, the features of which can be combined in any reasonable manner.

In some embodiments, the block vector may a block vector (BVx, BVy) with a first element, BVx, and a second element, BVy, the video unit may have a width W and a height H. In some embodiments, if BVx is equal to 0, BVy may be represented by coding the unsigned integer which depends on H. For example, the unsigned integer may be represented by h, and h≙((abs(BVy)−H), and BVy may be reconstructed as −(h+H). In one example, h≙((abs(BVy)−H) may be coded using EG1 and BVy may be recontructed as −(h+H).

In some other embodiments, if BVy is equal to 0, BVy may be represented by coding the unsigned integer which depends on W. For example, the unsigned integer may be represented by w, wherein w≙((abs(BVx)−W), and BVx may be recontructed as −(w+W). In one example, w ≙((abs(BVx)−W) may be coded using EG1 and BVx may be recontructed as −(w+W).

In some embodiments, a block vector for the video unit is determined. The video unit is applied with an intra block copy (IBC) mode and has a first size parameter and a second size parameter, and the block vector has a first direction parameter and a second direction parameter, and if the first direction parameter is equal to a predetermined number, an unsigned integer which depends on the first size parameter represents the second direction parameter. A bitstream of the video unit is generated based on the block vector.

In some embodiments, a block vector for the video unit is determined. The video unit is applied with an intra block copy (IBC) mode and has a first size parameter and a second size parameter, and the block vector has a first direction parameter and a second direction parameter, and if the first direction parameter is equal to a predetermined number, an unsigned integer which depends on the first size parameter represents the second direction parameter. A bitstream of the video unit is generated based on the block vector. The bitstream is stored in a non-transitory computer-readable recording medium.

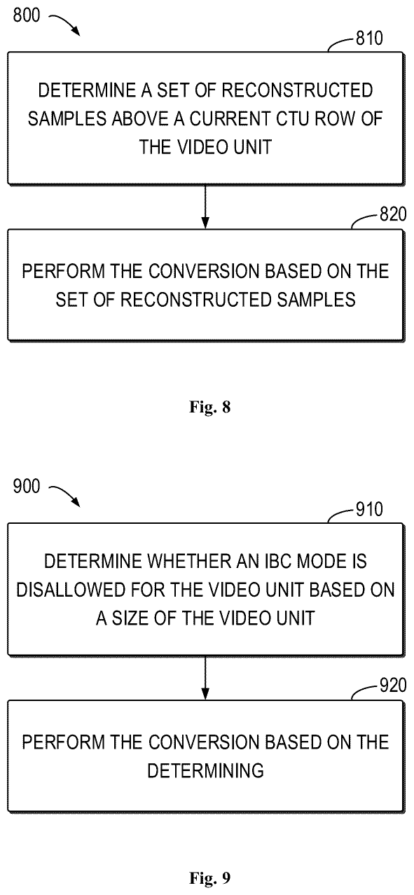

FIG. 8 illustrates a flowchart of a method 800 for video processing in accordance with some embodiments of the present disclosure. The method 800 may be implemented during a conversion between a block and a bitstream of the block.

As shown in FIG. 8, at block 810, during a conversion between a video unit of a video and a bitstream of the video, a set of reconstructed samples above a current coding tree unit (CTU) row of the video unit are determined to be used for intra block copy (IBC) reference. The IBC reference may generated from a signal in the IBC reference area.

At block 820, the conversion is performed based on the set of reconstructed samples. In some embodiments, the conversion may comprise encoding the video unit into the bitstream. In some embodiments, the conversion may comprise decoding the video unit from the bitstream.

According to embodiments of the present disclosure, the reconstructed samples above the CTU row of the video unit can be used for IBC reference. Compared with the conventional solution, embodiments of the present disclosure can advantageously improve the coding efficiency.

Implementations of the present disclosure can be described in view of the following clauses, the features of which can be combined in any reasonable manner.

In some embodiments, the set of reconstructed samples may be within a current slice of the video unit. In some other embodiments, the set of reconstructed samples may be within a current tile of the video unit. For example, another set of reconstructed samples outside the current tile may not be used as IBC reference.

In some embodiments, the set of reconstructed samples may be within a subpicture of the video unit. For example, another set of reconstructed samples outside the current subpicture may not be used as IBC reference.

In some embodiments, a set of reconstructed samples above a current coding tree unit (CTU) row of a video unit of the video are determined to be used for intra block copy (IBC) reference. A bitstream of the video unit is generated based on the set of reconstructed samples.

In some embodiments, a set of reconstructed samples above a current coding tree unit (CTU) row of a video unit of the video are determined to be used for intra block copy (IBC) reference. A bitstream of the video unit is generated based on the set of reconstructed samples. The bitstream is stored in a non-transitory computer-readable recording medium.

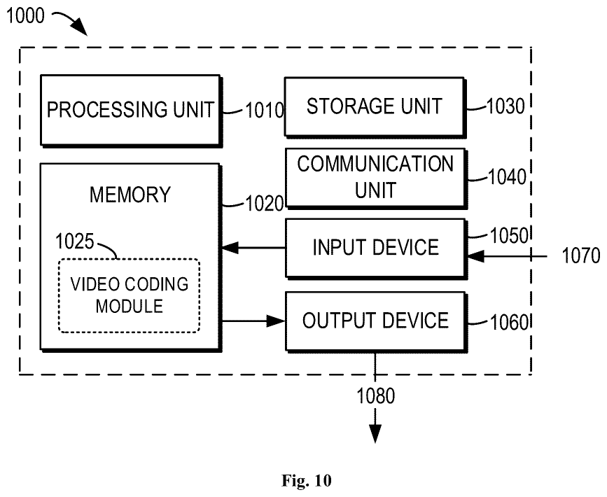

FIG. 9 illustrates a flowchart of a method 900 for video processing in accordance with some embodiments of the present disclosure. The method 900 may be implemented during a conversion between a block and a bitstream of the block.

As shown in FIG. 9, at block 910, during a conversion between a video unit of a video and a bitstream of the video, whether an intra block copy (IBC) mode is disallowed for the video unit is determined based on a size of the video unit. In some embodiments, the video unit may comprise one of: a coding tree unit (CTU) or a coding tree block (CTB).

At block 920, the conversion is performed based on the determining. In some embodiments, the conversion may comprise encoding the video unit into the bitstream. In some embodiments, the conversion may comprise decoding the video unit from the bitstream.

According to embodiments of the present disclosure, IBC may be disallowed for certain CTU/CTB sizes. Compared with the conventional solution, embodiments of the present disclosure can advantageously improve the coding efficiency.

Implementations of the present disclosure can be described in view of the following clauses, the features of which can be combined in any reasonable manner.

In some embodiments, the IBC mode may be disallowed if at least one of the followings is not smaller than a threshold value: a width of the video unit, or a height of the video unit. In some embodiments, the threshold value may be 128. In other some embodiments, the threshold value may be 256.

In some embodiments, if the IBC mode is disallowed for the video unit, the bitstream may indicate that IBC usage is skipped and inferred to 0. For example, when IBC is disallowed for those CTU size, the flag to indicate IBC usage may be skipped and inferred to be 0.

In some embodiments, whether an intra block copy (IBC) mode is disallowed for the video unit is determined based on a size of a video unit of the video. A bitstream of the video unit is determined based on the determining.

In some embodiments, whether an intra block copy (IBC) mode is disallowed for the video unit is determined based on a size of a video unit of the video. A bitstream of the video unit is determined based on the determining. The bitstream is stored in a non-transitory computer-readable recording medium.

In some example embodiments, the derivation process for block vector components for IBC block may be as shown in Table 5.

TABLE 5
8.6.2 Derivation process for block vector components for IBC blocks
8.6.2.1 General
Inputs to this process are:

| | |
|---|---|
| - | a luma location ( xCb, yCb ) of the top-left sample of the current luma coding block relative to the top-left luma |
| | sample of the current picture, |
| - | a variable cbWidth specifying the width of the current coding block in luma samples, |
| - | a variable cbHeight specifying the height of the current coding block in luma samples. |

Outputs of this process are:

| | |
|---|---|
| - | the luma block vector in 1/16 fractional-sample accuracy bvL. |

The luma block vector bvL is derived as follows:

| - | The derivation process for IBC luma block vector prediction as specified in clause 8.6.2.2 is invoked with the luma | |
|---|---|---|
| | location ( xCb, yCb ), the variables cbWidth and cbHeight inputs, and the output being the luma block vector bvL. | |
| - | When general_merge_flag[ xCb ][ yCb ] is equal to 0, the following applies: | |
| | 4. | The variable bvd is derived as follows: |

| | |
|---|---|
| bvd[ 0 ] = MvdL0[ xCb ][ yCb ][ 0 ] | (1081) |
| bvd[ 1 ] = MvdL0[ xCb ][ yCb ][ 1 ] | (1082) |

| | |
|---|---|
| 5. | The rounding process for motion vectors as specified in clause 8.5.2.14 is invoked with mvX set equal to |
| | bvL, rightShift set equal to AmvrShift, and leftShift set equal to AmvrShift as inputs and the rounded bvL |
| | as output. |
| 6. | The luma block vector bvL is modified as follows: |

| | |
|---|---|
| u[ 0 ] = ( bvL[ 0 ] + bvd[ 0 ] ) & ( 2¹⁸ − 1 ) | (1083) |

| | |
|---|---|
| bvL[ 0 ] = ( u[ 0 ] >= 2¹⁷ ) ? ( u[ 0 ] − 2¹⁸ ) : u[ 0 ] | (1084) |

| | |
|---|---|
| u[ 1 ] = ( bvL[ 1 ] + bvd[ 1 ] ) & ( 2¹⁸ − 1 ) | (1085) |

| | |
|---|---|
| bvL[ 1 ] = ( u >= 2¹⁷ ) ? ( u[ 1 ] − 2¹⁸ ) : u[ 1 ] | (1086) |

NOTE - The resulting values of bvL[ 0 ] and bvL[ 1 ] are in the range of −2¹⁷ to 2¹⁷ − 1, inclusive.

When IsGt4by4 is equal to TRUE, the updating process for the history-based block vector predictor list as specified in
clause 8.6.2.6 is invoked with luma block vector bvL.
It is a requirement of bitstream conformance that the luma block vector bvL shall obey the following constraints:

| | |
|---|---|
| - | IbcVirBuf[ 0 ][ ( x + (bvL[ 0 ] >> 4 ) ) & ( IbcBufWidthY − 1 ) ][ ( y + (bvL[ 1 ] >> 4 ) ) & ( IbcBufHeightY |
| | − 1 ) ] shall not be equal to −1 for x = xCb..xCb + cbWidth − 1 and y = yCb..yCb + cbHeight − 1. |

......

| | |
|---|---|
| xVb = ( xCurr + i ) % ( ( cIdx = = 0 ) ? IbcBufWidthY : IbcBufWidthC ) | (1197) |
| yVb = ( yCurr + j ) % ( ( cIdx = = 0 ) ? IbcBufHeightY : ( IbcBufHeightY / subHeightC ) ) | (1198) |
| IbcVirBuf[ cIdx ][ xVb ][ yVb ] = recSamples[ xCurr + i ][ yCurr + j ] | (1199) |

......
When cIdx is equal to 0, for x = xCb..xCb + cbWidth − 1 and y = yCb..yCb + cbHeight − 1, the following applies:

| | |
|---|---|
| xVb = ( x + ( bv[ 0 ] >> 4 ) ) & ( IbcBufWidthY − 1 ) | (1096) |

| | |
|---|---|
| yVb = ( y + ( bv[ 1 ] >> 4 ) ) & ( IbcBufHeightY − 1 ) | (1097) |

| | |
|---|---|
| predSamples [ x − xCb ][ y − yCb ] = IbcVirBuf[ 0 ][ xVb ][ yVb ] | (1098) |

When cIdx is not equal to 0, for x = xCb / SubWidthC..xCb / SubWidthC + cbWidth / SubWidthC − 1 and
y = yCb / SubHeightC..yCb / SubHeightC + cbHeight / SubHeightC − 1, the following applies:

| | |
|---|---|
| xVb = ( x + ( bv[ 0 ] >> ( 3 + SubWidthC ) ) ) & ( IbcBufWidthC − 1 ) | (1099) |
| yVb = ( y + ( bv[ 1 ] >> ( 3 + SubHeightC ) ) ) & ( ( IbcBufHeightY / subHeightC ) − 1 ) | (1100) |

| | |
|---|---|
| predSamples[ x − ( xCb / SubWidthC ) ][ y − ( yCb / SubHeightC ) ] = IbcVirBuf[ cIdx ][ xVb ][ yVb ] | (1101) |

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method of video processing, comprising: determining, during a conversion between a video unit of a video and a bitstream of the video, a first reference area for intra block copy (IBC) of the video unit based on a second reference area for intra template matching, the video unit being applied with an IBC mode; determining a block vector for the video unit in the first reference area; and performing the conversion based on the block vector.

Clause 2. The method of clause 1, wherein the first reference area for IBC is set corresponding to the second reference area for intra template matching.

Clause 3. The method of clause 1, wherein the second reference area for intra template matching is set corresponding to the first reference area for IBC.

Clause 4. The method of clause 1, wherein a reference area for each IBC block is set to a maximum area including a set of template samples if the vide unit is coded in the intra template matching mode.

Clause 5. The method of clause 1, wherein a reference area for each IBC block is set to a maximum area excluding a set of template samples if the vide unit is coded in the intra template matching mode.

Clause 6. A method of video processing, comprising: determining, during a conversion between a video unit of a video and a bitstream of the video, a block vector for the video unit, wherein the video unit is applied with an intra block copy (IBC) mode and has a first size parameter and a second size parameter, the block vector has a first direction parameter and a second direction parameter, and if the first direction parameter is equal to a predetermined number, an unsigned integer which depends on the first size parameter represents the second direction parameter; and performing the conversion based on the block vector.

Clause 7. The method of clause 6, wherein the block vector is a block vector (BVx, BVy) with a first element, BVx, and a second element, BVy, the video unit has a width W and a height H, and if BVx is equal to 0, BVy is represented by coding the unsigned integer which depends on H.

Clause 8. The method of clause 7, wherein the unsigned integer is repsented by h, wherein h((abs (BVy)−H), and BVy is recontructed as −(h+H).

Clause 9. The method of clause 6, wherein the block vector is a block vector (BVx, BVy) with a first element, BVx, and a second element, BVy, the video unit has a width W and a height H, and if BVy is equal to 0, BVy is represented by coding the unsigned integer which depends on W.

Clause 10. The method of clause 9, wherein the unsigned integer is represented by w, wherein w((abs (BVx)−W), and BVx is recontructed as −(w+W).

Clause 11. A method of video processing, comprising: determining, during a conversion between a video unit of a video and a bitstream of the video, a set of reconstructed samples above a current coding tree unit (CTU) row of the video unit are used for intra block copy (IBC) reference; and performing the conversion based on the set of reconstructed samples.

Clause 12. The method of clause 11, wherein the set of reconstructed samples are within a current slice of the video unit.

Clause 13. The method of clause 11, wherein the set of reconstructed samples are within a current tile of the video unit.

Clause 14. The method of clause 13, wherein another set of reconstructed samples outside the current tile are not used as IBC reference.

Clause 15. The method of clause 11, wherein the set of reconstructed samples are within a subpicture of the video unit.

Clause 16. The method of clause 11, wherein another set of reconstructed samples outside the current subpicture are not used as IBC reference.

Clause 17. A method of video processing, comprising: determining, during a conversion between a video unit of a video and a bitstream of the video, whether an intra block copy (IBC) mode is disallowed for the video unit based on a size of the video unit; and performing the conversion based on the determining.

Clause 18. The method of clause 17, wherein the video unit comprises one of: a coding tree unit (CTU) or a coding tree block (CTB).

Clause 19. The method of clause 17, wherein the IBC mode is disallowed if at least one of the followings is not smaller than a threshold value: a width of the video unit, or a height of the video unit.

Clause 20. The method of clause 19, wherein the threshold value is 128 or 256.

Clause 21. The method of clause 17, wherein if the IBC mode is disallowed for the video unit, the bitstream indicates that IBC usage is skipped and inferred to 0.

Clause 22. The method of any of clauses 1-21, wherein in the IBC mode, prediction samples are derived from blocks of sample values of a same video region as determined by block vectors.

Clause 23. The method of any of clauses 1-22, wherein the conversion includes encoding the video unit into the bitstream.

Clause 24. The method of any of clauses 1-22, wherein the conversion includes decoding the video unit from the bitstream.

Clause 25. An apparatus for processing video data comprising a processor and a non-transitory memory with instructions thereon, wherein the instructions upon execution by the processor, cause the processor to perform a method in accordance with any of clauses 1-24.

Clause 26. A non-transitory computer-readable storage medium storing instructions that cause a processor to perform a method in accordance with any of clauses 1-24.

Clause 27. A non-transitory computer-readable recording medium storing a bitstream of a video which is generated by a method performed by a video processing apparatus, wherein the method comprises: determining a first reference area for intra block copy (IBC) of a video unit of the video based on a second reference area for intra template matching, the video unit being applied with an IBC mode; determining a block vector for the video unit in the first reference area; and generating a bitstream of the video unit based on the block vector.

Clause 28. A method for storing bitstream of a video, comprising: determining a first reference area for intra block copy (IBC) of a video unit of the video based on a second reference area for intra template matching, the video unit being applied with an IBC mode; determining a block vector for the video unit in the first reference area; generating a bitstream of the video unit based on the block vector; and storing the bitstream in a non-transitory computer-readable recording medium.

Clause 29. A non-transitory computer-readable recording medium storing a bitstream of a video which is generated by a method performed by a video processing apparatus, wherein the method comprises: determining a block vector for the video unit, wherein the video unit is applied with an intra block copy (IBC) mode and has a first size parameter and a second size parameter, and the block vector has a first direction parameter and a second direction parameter, and if the first direction parameter is equal to a predetermined number, an unsigned integer which depends on the first size parameter represents the second direction parameter; and generating a bitstream of the video unit based on the block vector.

Clause 30. A method for storing bitstream of a video, comprising: determining a block vector for a video unit of the video, wherein the video unit is applied with an intra block copy (IBC) mode and has a first size parameter and a second size parameter, and the block vector has a first direction parameter and a second direction parameter, and if the first direction parameter is equal to a predetermined number, an unsigned integer which depends on the first size parameter represents the second direction parameter; and generating a bitstream of the video unit based on the block vector; and storing the bitstream in a non-transitory computer-readable recording medium.

Clause 31. A non-transitory computer-readable recording medium storing a bitstream of a video which is generated by a method performed by a video processing apparatus, wherein the method comprises: determining a set of reconstructed samples above a current coding tree unit (CTU) row of a video unit of the video are used for intra block copy (IBC) reference; and generating a bitstream of the video unit based on the set of reconstructed samples.

Clause 32. A method for storing bitstream of a video, comprising: determining a set of reconstructed samples above a current coding tree unit (CTU) row of a video unit of the video are used for intra block copy (IBC) reference; generating a bitstream of the video unit based on the set of reconstructed samples; and storing the bitstream in a non-transitory computer-readable recording medium.

Clause 33. A non-transitory computer-readable recording medium storing a bitstream of a video which is generated by a method performed by a video processing apparatus, wherein the method comprises: determining, based on a size of a video unit of the video, whether an intra block copy (IBC) mode is disallowed for the video unit; and generating a bitstream of the video unit based on the determining.

Clause 34. A method for storing bitstream of a video, comprising: determining, based on the size of a video unit of the video, whether an intra block copy (IBC) mode is disallowed for the video unit; generating a bitstream of the video unit based on the determining; and storing the bitstream in a non-transitory computer-readable recording medium.

### Example Device

FIG. 10 illustrates a block diagram of a computing device 1000 in which various embodiments of the present disclosure can be implemented. The computing device 1000 may be implemented as or included in the source device 110 (or the video encoder 114 or 200) or the destination device 120 (or the video decoder 124 or 300).

It would be appreciated that the computing device 1000 shown in FIG. 10 is merely for purpose of illustration, without suggesting any limitation to the functions and scopes of the embodiments of the present disclosure in any manner.

As shown in FIG. 10, the computing device 1000 includes a general-purpose computing device 1000. The computing device 1000 may at least comprise one or more processors or processing units 1010, a memory 1020, a storage unit 1030, one or more communication units 1040, one or more input devices 1050, and one or more output devices 1060.

In some embodiments, the computing device 1000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1000 can support any type of interface to a user (such as “wearable” circuitry and the like).

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem and the like) enabling the computing device 1000 to communicate with one or more other computing devices, if required. Such communication can be performed via input/output (I/O) interfaces (not shown).

In some embodiments, instead of being integrated in a single device, some or all components of the computing device 1000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1000 may be used to implement video encoding/decoding in embodiments of the present disclosure. The memory 1020 may include one or more video coding modules 1025 having one or more program instructions. These modules are accessible and executable by the processing unit 1010 to perform the functionalities of the various embodiments described herein.

In the example embodiments of performing video encoding, the input device 1050 may receive video data as an input 1070 to be encoded. The video data may be processed, for example, by the video coding module 1025, to generate an encoded bitstream. The encoded bitstream may be provided via the output device 1060 as an output 1080.

In the example embodiments of performing video decoding, the input device 1050 may receive an encoded bitstream as the input 1070. The encoded bitstream may be processed, for example, by the video coding module 1025, to generate decoded video data. The decoded video data may be provided via the output device 1060 as the output 1080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a video unit of a video and a bitstream of the video, a first reference area for intra block copy (IBC) of the video unit based on a second reference area for intra template matching, the video unit being applied with an IBC mode;
determining a block vector for the video unit in the first reference area; and
performing the conversion based on the block vector.

2. The method of claim 1, wherein the first reference area for IBC is set corresponding to the second reference area for intra template matching.

3. The method of claim 1, wherein the second reference area for intra template matching is set corresponding to the first reference area for IBC.

4. The method of claim 1, wherein a reference area for each IBC block is set to a maximum area including a set of template samples if the vide unit is coded in the intra template matching mode.

5. The method of claim 1, wherein the video unit has a first size parameter and a second size parameter, the block vector has a first direction parameter and a second direction parameter, and if the first direction parameter is equal to a predetermined number, an unsigned integer which depends on the first size parameter represents the second direction parameter.

6. The method of claim 5, wherein the block vector is a block vector (BVx, BVy) with a first element, BVx, and a second element, BVy, the video unit has a width W and a height H, and
if BVx is equal to 0, BVy is represented by coding the unsigned integer which depends on H.

7. The method of claim 6, wherein the unsigned integer is repsented by h, wherein h≙((abs (BVy))−H), and BVy is recontructed as −(h+H).

8. The method of claim 5, wherein the block vector is a block vector (BVx, BVy) with a first element, BVx, and a second element, BVy, the video unit has a width W and a height H, and
if BVy is equal to 0, BVy is represented by coding the unsigned integer which depends on W.

9. The method of claim 8, wherein the unsigned integer is represented by w, wherein w≙((abs(BVx))−W), and BVx is recontructed as −(w+W).

10. The method of claim 1, further comprising:
determining that a set of reconstructed samples above a current coding tree unit (CTU) row of the video unit are used for IBC reference.

11. The method of claim 10, wherein the set of reconstructed samples are within a current slice of the video unit, or
wherein the set of reconstructed samples are within a current tile of the video unit.

12. The method of claim 10, wherein another set of reconstructed samples outside the current tile are not used as IBC reference.

13. The method of claim 10, wherein the set of reconstructed samples are within a subpicture of the video unit.

14. The method of claim 10, wherein another set of reconstructed samples outside the current subpicture are not used as IBC reference.

15. The method of claim 1, wherein in the IBC mode, prediction samples are derived from blocks of sample values of a same video region as determined by block vectors.

16. The method of claim 1, wherein the conversion includes encoding the video unit into the bitstream.

17. The method of claim 1, wherein the conversion includes decoding the video unit from the bitstream.

18. An apparatus for processing video data comprising a processor and a non-transitory memory with instructions thereon, wherein the instructions upon execution by the processor, cause the processor to perform acts comprising:
determining, during a conversion between a video unit of a video and a bitstream of the video, a first reference area for intra block copy (IBC) of the video unit based on a second reference area for intra template matching, the video unit being applied with an IBC mode;
determining a block vector for the video unit in the first reference area; and
performing the conversion based on the block vector.

19. A non-transitory computer-readable storage medium storing instructions that cause a processor to perform acts comprising:
determining, during a conversion between a video unit of a video and a bitstream of the video, a first reference area for intra block copy (IBC) of the video unit based on a second reference area for intra template matching, the video unit being applied with an IBC mode;
determining a block vector for the video unit in the first reference area; and
performing the conversion based on the block vector.

20. A non-transitory computer-readable recording medium storing a bitstream of a video which is generated by a method performed by a video processing apparatus, wherein the method comprises:
determining a first reference area for intra block copy (IBC) of a video unit of the video based on a second reference area for intra template matching, the video unit being applied with an IBC mode;
determining a block vector for the video unit in the first reference area; and
generating a bitstream of the video unit based on the block vector.
